(19) United States
(12) Patent Application Publication
(10) Pub. No.: US 2018/0096209 A1
(43) Pub. Date: Apr. 5, 2018

(54) NON-TRANSITORY COMPUTER-READABLE STORAGE MEDIUM, EVENT DETECTION APPARATUS, AND EVENT DETECTION METHOD

(71) Applicant: FUJITSU LIMITED, Kawasaki-shi (JP)

(72) Inventors: Yuji Matsuda, Kawasaki (JP); Kentaro Tsuji, Kawasaki (JP); Mingxie Zheng, Kawasaki (JP); Nobuhiro Miyazaki, Kawasaki (JP); Eigo Segawa, Kawasaki (JP)

(73) Assignee: FUJITSU LIMITED, Kawasaki-shi (JP)

(21) Appl. No.: 15/708,435

(22) Filed: Sep. 19, 2017

(30) Foreign Application Priority Data
Sep. 30, 2016 (JP) 2016-194224

(51) Int. Cl. G06K 9/00; G06K 9/20; G06K 9/46

(52) U.S. Cl. CPC G06K 9/00771; G06K 9/209; G06K 2209/21; G06K 9/00362; G06K 9/00335; G06K 9/46

(57) ABSTRACT

A non-transitory computer-readable storage medium storing an event detection program that causes a computer to perform a process, the process including acquiring a first captured image captured at a first timing by a first camera device, acquiring a second captured image captured at a second timing after the first timing by a second camera device, detecting an event in accordance with a first image feature extracted from the first captured image, a second image feature extracted from the second captured image and an event detection criteria, the event detection criteria making the event less detectable as a variance of the first image feature or a variance of the second image feature is smaller, both the first image feature and the second image feature corresponding to one or more target objects, and outputting a result of the detecting of the event.

### CROSS-REFERENCE TO RELATED APPLICATION

This application is based upon and claims the benefit of priority of the prior Japanese Patent Application No. 2016-194224, filed on Sep. 30, 2016, the entire contents of which are incorporated herein by reference.

### FIELD

The embodiments discussed herein are related to a non-transitory computer-readable storage medium, an event detection apparatus, and an event detection method.

### BACKGROUND

Techniques of tracking of a person using a video captured by a surveillance camera are disclosed.

An information processing apparatus is disclosed that searches for and keeps track of a person as a track target with high precision from images captured by multiple cameras. The information processing apparatus captures images with multiple imaging units. The information processing apparatus detects a moving object from the images, extracts a moving image from the images of the detected moving object, detects spatial position coordinates of the moving object in accordance with the moving image, and outputs moving object information including the moving image, the spatial position coordinates of the moving object, and the imaging time of the captured image. The information processing apparatus determines whether each of spatial and temporal likelihoods is higher or lower than each specific threshold, and deletes the moving object information of the spatial and temporal likelihoods lower than the respective threshold values from a search result moving object information memory. The information processing apparatus thus increases the precision level of search and track results.

A person tracking apparatus is disclosed that tracks the same person in images captured at multiple photographing areas to calculate a traffic line of the same person. The person tracking apparatus extracts feature quantities from a person image, and checks one feature quantity with another to determine persons through a specific determination method. The person tracking apparatus performs person authentication by determining whether the two person images with the feature quantities thereof extracted represent the same person or different persons. Based on information concerning the photographing areas and times respectively for the two person images that are authenticated as the same person, the person tracking apparatus determines whether the authentication results indicating that the two person images represent the same person are correct. The person tracking apparatus then calculates the traffic line of the person, based on the photographing areas and times for the person images of the persons authenticated to be the same person in the authentication results of the same person that are determined to be correct.

A dwell time measurement apparatus is disclosed that measures a dwell time in a certain space. The dwell time measurement apparatus determines entrance person image information and exit person image information of the same person respectively from multiple pieces of entrance person image information and multiple pieces of exit person image information. The dwell time measurement apparatus acquires entrance time information corresponding to an entrance image that serves as a source from which a same person recognition unit acquires the determined entrance person image information, and acquires exit time information corresponding to an exit image that serves as a source from which a same person recognition unit acquires the determined exit person image information. The dwell time measurement apparatus calculates a dwell time period from the entrance to the exit. The dwell time measurement apparatus determines whether the calculated dwell time is normal or not.

Reference is made to International Publication Pamphlet No. WO2013/108686, Japanese Laid-open Patent Publication No. 2006-236255, and Japanese Laid-open Patent Publication No. 2012-137906.

### SUMMARY

According to an aspect of the invention, a non-transitory computer-readable storage medium storing an event detection program that causes a computer to perform a process, the process including acquiring a first captured image captured at a first timing by a first camera device, acquiring a second captured image captured at a second timing after the first timing by a second camera device, detecting an event in accordance with a first image feature extracted from the first captured image, a second image feature extracted from the second captured image and an event detection criteria, the event detection criteria making the event less detectable as a variance of the first image feature or a variance of the second image feature is smaller, both the first image feature and the second image feature corresponding to one or more target objects included in each of the first captured image and the second captured image, and outputting a result of the detecting of the event.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a case in which persons dwell at a location different from photographing areas;

FIG. 2 illustrates a case in which an anomaly occurs in a location different from the photographing areas;

FIG. 3 is a functional block diagram diagrammatically illustrating an event detection system of an embodiment;

FIG. 4 illustrates an example of an image table;

FIG. 5 illustrates an example of a person information table;

FIG. 6 illustrates an example of a threshold value table;

FIG. 7 illustrates an example of person regions detected from a captured image under a normal condition;

FIG. 8 illustrates an example of person regions detected from a captured image when an anomaly occurs;

FIG. 9 is a block diagram diagrammatically illustrating a computer that operates as the event detection apparatus of the embodiment;

FIG. 10 is a flowchart illustrating an example of a threshold value setting process in accordance with a first embodiment;

FIG. 11 is a flowchart illustrating an example of a same person determination process in accordance with an embodiment;

FIG. 12 is a flowchart illustrating an example of an anomaly determination process in accordance with the first embodiment;

FIG. 13 illustrates an operation example in which variations in a feature quantity of person regions detected from a captured image are large;

FIG. 14 illustrates an operation example in which variations in a feature quantity of person regions detected from a captured image are small;

FIG. 15 is a flowchart illustrating an example of a threshold value setting process in accordance with a second embodiment;

FIG. 16 is a flowchart illustrating an example of an anomaly determination process in accordance with the second embodiment;

FIG. 17 illustrates an anomaly that is detected using a movement ratio of persons; and

FIG. 18 illustrates an anomaly that is detected using a movement ratio of persons.

### DESCRIPTION OF EMBODIMENTS

When a wide area is monitored using images captured by multiple camera devices, an anomaly in each camera device is also detected. For this reason, target objects included in the captured images are collated among them, and the occurrence of an event in a monitoring area is thus detected. In such a case, if multiple targets similar in feature are included in the captured images, an accuracy level of collating the target objects among the captured images is lowered. Person may be collated as a target. If multiple persons wearing similar clothes are present in multiple captured images, different persons may be determined to be the same person from among the captured images. This presents difficulty in appropriately detecting the occurrence of an event.

The embodiments discussed herein are intended to control an event detection error even if a collation error based on a feature quantity extracted from each of the captured images is likely to occur.

Detection of Anomaly Based on Captured Images

A large number of camera devices are mounted at crowded places, such as on busy streets, or commercial facilities for safety and disaster prevention purposes. Since it is difficult to manually check videos including a high volume of captured images, an anomaly, if created, is desirably automatically detected.

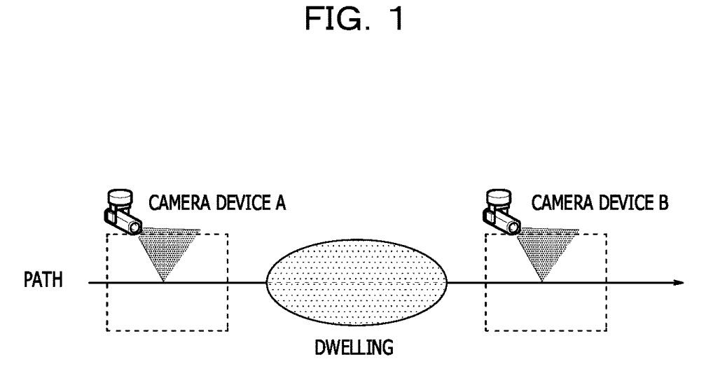

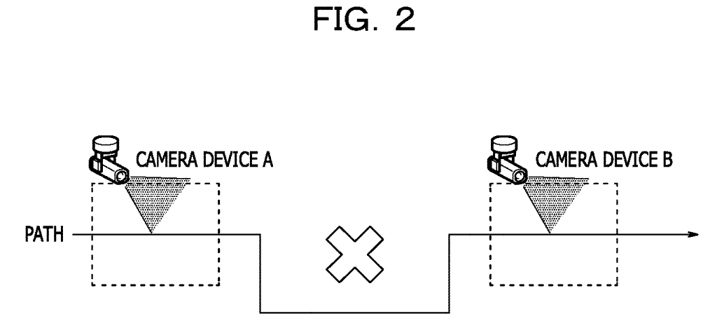

A detection area, if too large, is not fully covered with the camera devices. In such a case, if an anomaly occurs outside a photographing area, it is not detected. FIG. 1 and FIG. 2 illustrate examples in which an anomaly occurs.

Referring to FIG. 1 and FIG. 2, the photographing area of a camera device A is different from the photographing area of a camera device B. If persons dwell as illustrated in FIG. 1, or an anomaly occurs at a location labeled with a symbol x as illustrated in FIG. 2, such events go undetected. To set a wide area to be a detection target, camera devices are mounted at locations to fully cover the detection area.

If dwelling as an anomaly occurs in an area different from the photographing areas, and the dwelling location is in the moving path of people as illustrated in FIG. 1, it takes time for people to move through the dwelling location. If an anomaly occurs at the location labeled with the symbol x and in the moving path of people as illustrated in FIG. 2, the moving path is changed to detour the location of the anomaly, and travel time changes.

In accordance with an embodiment, multiple camera devices are mounted in an environment that causes no overlapping photographing regions. Depending on the moving tendency of people photographed in the image, an anomaly having occurred at a location different from the photographing area is detected. For example, in accordance with the embodiment, if an anomaly has occurred, a change occurs in the moving path and moving speed of people. The occurrence of the anomaly is thus detected in response to the changes in the movement of people.

Embodiments are described below with reference to the drawings.

### First Embodiment

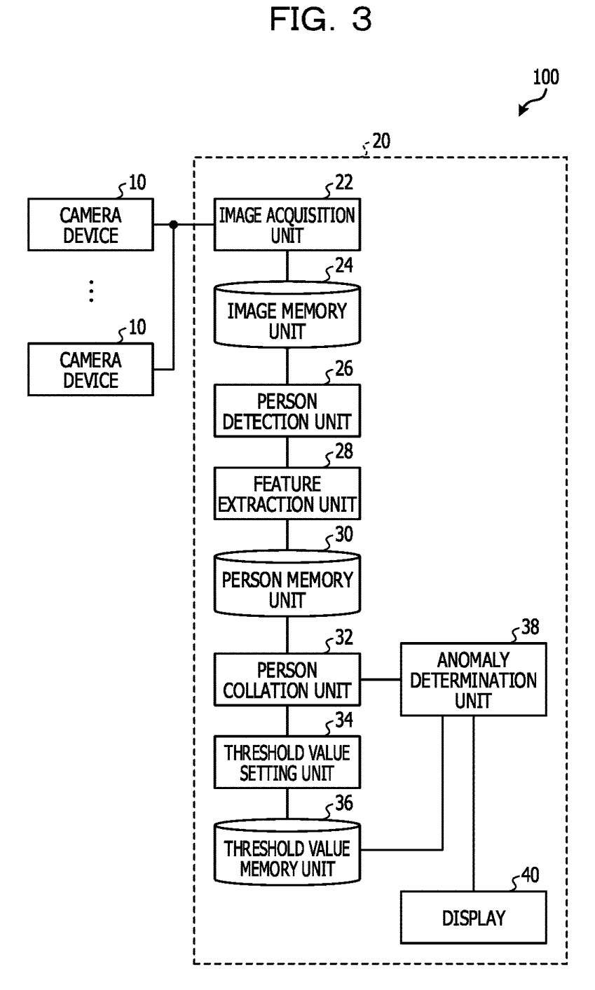

As illustrated in FIG. 3, an event detection system 100 of a first embodiment includes multiple camera devices 10 and an event detection apparatus 20.

The camera devices 10 capture images. Each of the camera devices 10 is tagged with a respective identifier (ID). Images captured by the camera devices 10 are tagged with camera device IDs and imaging time serving as identification information of each frame.

The event detection apparatus 20 analyzes each of the images captured by the camera devices 10, and detects an anomaly as an example of an event. Referring to FIG. 3, the event detection apparatus 20 includes an image acquisition unit 22, an image memory unit 24, a person detection unit 26, a feature extraction unit 28, a person memory unit 30, a person collation unit 32, a threshold value setting unit 34, a threshold value memory unit 36, an anomaly determination unit 38, and a display 40. The anomaly determination unit 38 is an example of a detection unit and a controller.

The image acquisition unit 22 acquires images captured by the camera devices 10. The image acquisition unit 22 then associates the acquired images with the camera device IDs thereof and the imaging times of the frames thereof, and then stores the associated images on the image memory unit 24.

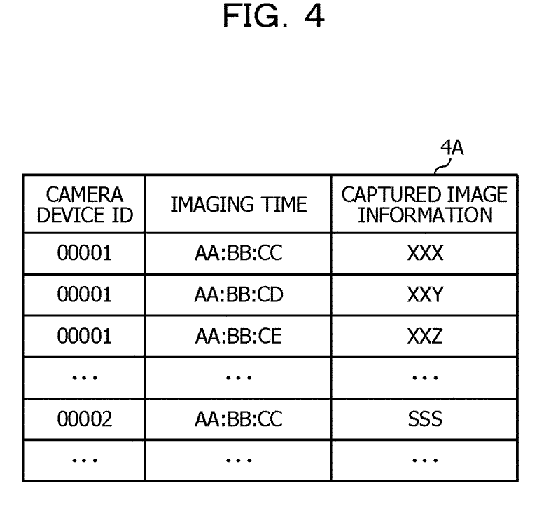

The image memory unit 24 stores multiple images acquired by the image acquisition unit 22 in the form of a captured image table. FIG. 4 illustrates an example of a captured image table 4A to be stored on the image memory unit 24. As illustrated in FIG. 4, the camera device IDs, the imaging times, and captured image information are associated and then stored in the captured image table 4A.

The person detection unit 26 detects a person region included in each of the captured images stored on the image memory unit 24.

More specifically, the person detection unit 26 detects the person region included in the captured image using a discriminator that is produced in advance. For example, background difference methods as described in Literature 1 and Literature 2 listed below, and a discriminator based on histograms of oriented gradients (HOG) features are produced in advance.

Reference is made to Literature 1: “Moving Object Detection by Time-Correlation-Based Background Judgment Method”, Proceedings of the Institute of Electronics, Information and Communication Engineers, D-II, vol. J79, No. 4, pp. 568-576, 1996.

Reference is made to Literature 2: “Human Detection Based on Statistical Learning from Image”, Proceedings of the Institute of Electronics, Information and Communication Engineers, vol. J96-D, No. 9, pp. 2017-2040, 2013.

The feature extraction unit 28 extracts a feature quantity from a person region of the captured image detected by the person detection unit 26. For example, the feature extraction unit 28 extracts a color histogram of the person region as the feature quantity. The feature extraction unit 28 associates a person region ID serving as identification information of the person region, the image device ID and the imaging time of the captured image from which the person region has been detected, and the feature quantity of the person region, and then stores these associated pieces of information on the person memory unit 30.

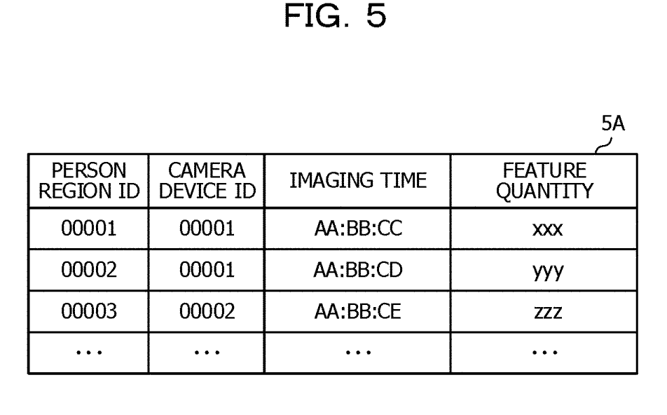

The feature quantities of the person regions extracted by the feature extraction unit 28 are stored in the form of a person information table in which each feature quantity is associated with a person region ID, a camera device ID, and imaging time. FIG. 5 illustrates an example of the person information table 5A to be stored on the person memory unit 30. Referring to FIG. 5, the person region IDs, the camera device IDs, the imaging times, and the feature quantities are respectively associated to each other and then stored in the person information table 5A.

Using the information stored in the person information table 5A of the person memory unit 30, the person collation unit 32 compares the feature quantity of a person region extracted from a captured image from a specific camera device 10 with the feature quantity of a person region extracted from a captured image from another camera device 10. If the feature quantities of the person regions satisfy a similarity criteria, the person collation unit 32 determines in collation results that the person regions are those of the same person.

More specifically, the person collation unit 32 compares the feature quantities of each pair of person region IDs different in terms of camera device ID stored in the person information table 5A, and determines whether the person regions indicate the same person. If a color histogram is used as the feature quantity, a distance between colors having a high frequency of occurrence or a distance or a correlation value between the histograms may be used (reference is made to Japanese Laid-open Patent Publication No. 2005-250692, and Japanese Laid-open Patent Publication No. 2011-18238).

The person collation unit 32 determines whether each pair of person region IDs having the same imaging ID but having different imaging times indicate the person areas of the same person. If the person collation unit 32 determines that a pair of person region IDs having the same imaging ID but having different imaging times indicates the person areas of the same person, the anomaly determination unit 38 performs anomaly detection using collation results of a person region having the earliest imaging time. If the number of the same person regions being different in imaging time but having the same camera device ID is plural, measurement results concerning an appropriate number of moving persons are not obtained. The collation results for the person region having the earliest imaging time are thus used.

The threshold value setting unit 34 sets a threshold value and a criteria value of anomaly determination on each pair of different image device IDs, in accordance with the collation results obtained by the person collation unit 32 under a normal condition free from anomaly. By comparing the threshold values and criteria values on each pair of different image device IDs obtained from captured images from the camera devices 10, and calculating a threshold value and a criteria value of anomaly determination, the threshold value setting unit 34 sets to be the threshold value and criteria value of anomaly determination a moving tendency of people at locations where the image devices 10 are mounted.

More specifically, the threshold value setting unit 34 calculates the number of moving persons between locations per unit time where the camera devices 10 are present, based on the collation results of each of the images captured by the camera devices 10 under the normal condition free from any anomaly.

More in detail, based on the collation results of the person regions obtained by the person collation unit 32, the threshold value setting unit 34 repeatedly measures the number of moving persons between locations corresponding to a pair of the camera device IDs under the normal condition for a specific period of time with respect to each pair of the camera device IDs. The threshold value setting unit 34 thus calculates a range of the number of moving persons under the normal condition. When the number of moving persons is calculated, a time segment corresponding to unit time is set up, and the number of person regions determined to be the same persons from the start time to the end time of the time segment is calculated as the number of moving persons. The threshold value setting unit 34 sets to be a criteria value a mean value of moving persons under the normal condition with respect to the pair of camera device IDs, and sets to be a threshold value a value that results from multiplying the standard deviation of the number of moving persons under the normal condition by N. If the number of moving persons follows the normal distribution, 95% of the moving persons falls within a range of (mean value±2×standard deviation) and 99% of the moving persons falls within a range of (mean value±3×standard deviation). N is thus set to be a value between 2 and 3. The threshold value setting unit 34 stores the set criteria value and threshold value of anomaly determination and the camera device ID pair in association with each other on the threshold value memory unit 36.

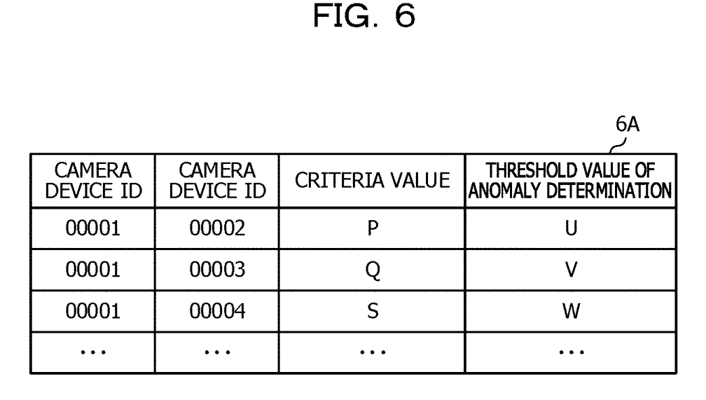

The threshold value memory unit 36 stores in the form of a threshold value table the criteria value and the anomaly determination threshold value set by the threshold value setting unit 34. FIG. 6 illustrates an example of a threshold value table 6A that lists the criteria value and threshold value of each camera device ID pair. Referring to FIG. 6, each camera device ID pair, the criteria value and threshold value thereof are stored in association with each other.

Based on the collation results obtained by the person collation unit 32 in real time, the anomaly determination unit 38 calculates the number of moving persons between the locations corresponding to the pair of different camera devices 10, and detects an anomaly by comparing the number of moving persons with the threshold value of anomaly determination serving as an example of an event detection criteria.

More specifically, based on the collation results of the person regions obtained by the person collation unit 32 in real time, the anomaly determination unit 38 calculates the number of moving persons between the locations corresponding to the pair per unit time with respect to each pair of different camera device IDs. Based on the calculated number of moving persons, and the criteria value and threshold value of anomaly determination stored on the threshold value memory unit 36, the anomaly determination unit 38 detects the occurrence of an anomaly if the number of moving persons falls outside the criteria value by the threshold value of anomaly determination or more.

If an anomaly takes place at a location different from the photographing areas of the camera devices 10, the embodiment pays attention to a change that occurs in the moving tendency of people are passing that location. For example, an anomaly is detected, based on the number and moving time of moving persons detected from the images captured by the camera devices 10. The embodiment is described by referring to the case in which an anomaly is detected using the number of moving persons.

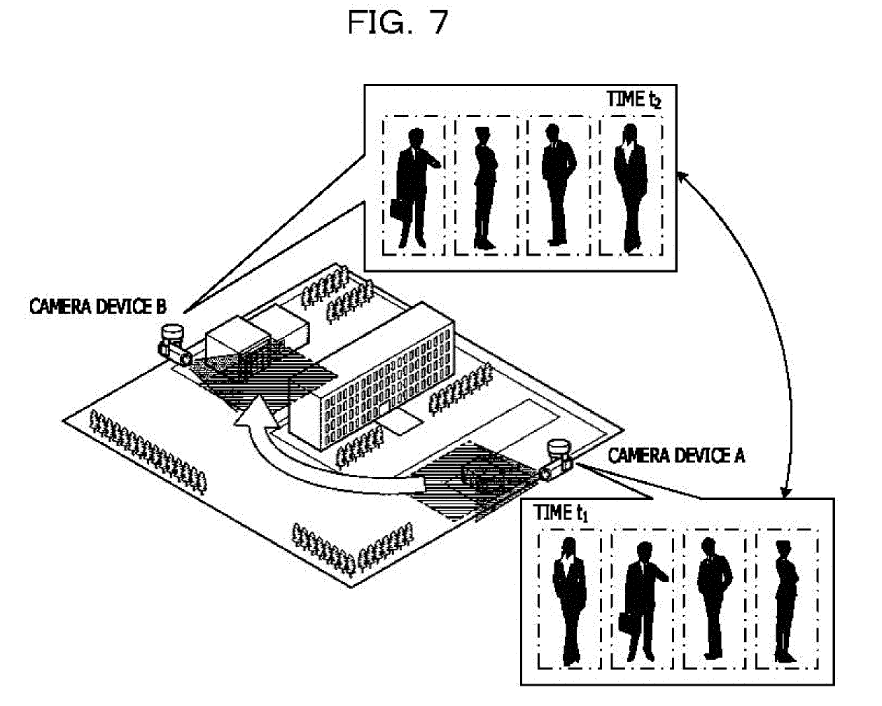

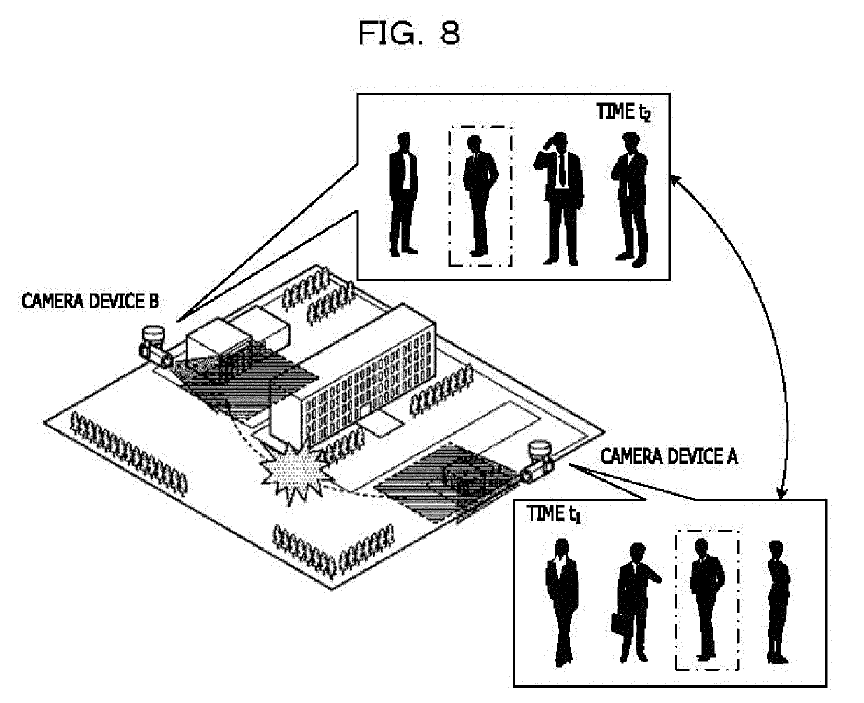

FIG. 7 and FIG. 8 illustrate the case in which an anomaly is detected from the captured image. Under the normal condition as illustrated in FIG. 7, t four persons are detected from the image captured by the camera device A at time t₁, and the same four persons are detected from the image captured by the camera device B at time t₂. In this case, it is recognized that the persons are moving from a location within the photographing area of the camera device A to a location within the photographing area of the camera device B. As illustrated in FIG. 7, a moving path as represented by an arrow mark is present.

As illustrated in FIG. 8, on the other hand, an anomaly has taken place in the moving path of people. Out of the four persons detected from the captured image from the camera device A at time t₁, only one person is detected from the captured image from the camera device B at t₂. It is thus recognized that the number of persons moving from a location within the photographing area of the camera device A to a location within the photographing area of the camera device B is smaller than the number of moving persons under the normal condition.

In accordance with the embodiment, a person moving from one location to another corresponding to the photographing areas is tracked by detecting the person regions from multiple captured images and collating the same person. Under the normal condition, the number of persons moving the locations corresponding to the photographing areas photographed by the camera devices is calculated and a standard value is defined for the number of persons in advance. If the number of persons moving between the locations corresponding to the photographing areas photographed by the camera devices deviates from the standard value by a predetermined difference value or higher, an anomaly is determined to take place.

The display 40 displays determination results that are obtained by the anomaly determination unit 38 and indicate whether an anomaly is taking place or not.

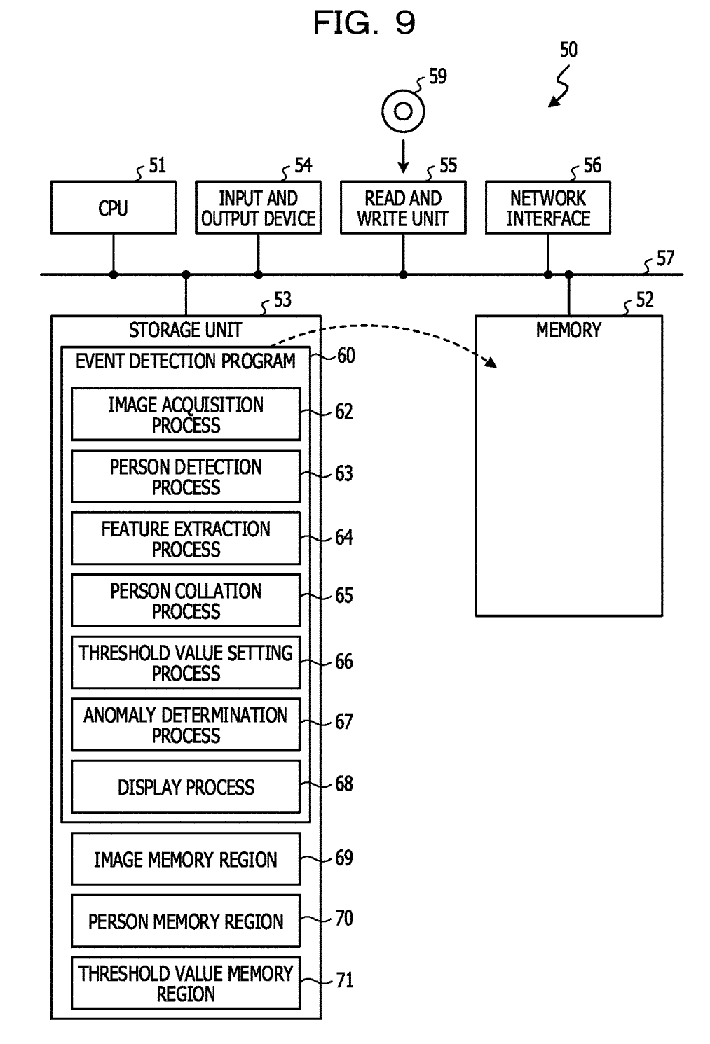

The event detection apparatus 20 may be implemented using a computer 50 of FIG. 9. The computer 50 includes a central processing unit (CPU) 51, a memory 52 serving as a temporary storage region, and a non-volatile storage unit 53. The computer 50 includes a read and write unit 55 that controls data reading from and data writing to an input and output device 54, such as a display or an input device, and a recording medium 59. The computer 50 also includes a network interface 56 that is connected to a network, such as the Internet. The CPU 51, the memory 52, the storage unit 53, the input and output device 54, the read and write unit 55, and the network interface 56 are interconnected to each other via a bus 57.

The storage unit 53 is implemented by a hard disk drive (HDD), a solid-state drive (SSD), a flash memory, or the like. The storage unit 53 serving as a memory medium stores an event detection program 60 that causes the computer 50 to operate as the event detection apparatus 20. The event detection program 60 includes an image acquisition process 62, a person detection process 63, a feature extraction process 64, a person collation process 65, a threshold value setting process 66, an anomaly determination process 67, and a display process 68. The storage unit 53 also includes an image memory region 69 that stores information and forms the image memory unit 24, a person memory region 70 that stores information and forms the person memory unit 30, and a threshold memory region 71 that stores information and forms the threshold value memory unit 36.

The CPU 51 reads the event detection program 60 from the storage unit 53 and expands the event detection program 60 onto the memory 52, and successively performs processes included in the event detection program 60. The CPU 51 operates as the image acquisition unit 22 of FIG. 3 by performing the image acquisition process 62. The CPU 51 operates as the person detection unit 26 of FIG. 3 by performing the person detection process 63. The CPU 51 operates as the feature extraction unit 28 of FIG. 3 by performing the feature extraction process 64. The CPU 51 operates as the person collation unit 32 of FIG. 3 by performing the person collation process 65. The CPU 51 operates as the threshold value setting unit 34 of FIG. 3 by performing the threshold value setting process 66. The CPU 51 operates as the anomaly determination unit 38 of FIG. 3 by performing the anomaly determination process 67. The CPU 51 operates as the display 40 of FIG. 3 by performing the display process 68. The CPU 51 reads the information from the image memory region 69 and expands the image memory unit 24 onto the memory 52. The CPU 51 reads the information from the person memory region 70 and expands the person memory unit 30 onto the memory 52. The CPU 51 reads the information from the threshold memory region 71 and expands the threshold value memory unit 36 onto the memory 52. In this way, the computer 50 functions as the event detection apparatus 20 by executing the event detection program 60.

The functions to be performed by the event detection program 60 may be implemented using a semiconductor integrated circuit, such as an application specific integrated circuit (ASIC) or the like.

The processes of an event detection system 100 of the embodiment are described below. In accordance with the embodiment, a threshold value setting process to set the criteria value and threshold value of anomaly determination and an anomaly determination process are performed.

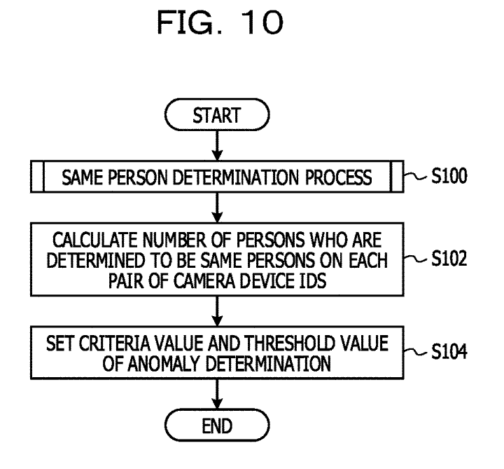

The threshold value setting process to set the criteria value and threshold value of anomaly determination is described below. In the processes of an event detection system 100 under the normal state, multiple camera devices 10 capture images, and the image acquisition unit 22 in the event detection apparatus 20 acquires each of the images captured by the camera devices 10. When each of the captured images acquired by the image acquisition unit 22 is stored in an image table on the image memory unit 24, the event detection apparatus 20 performs the threshold value setting process of FIG. 10. Each of operations in the process is described below.

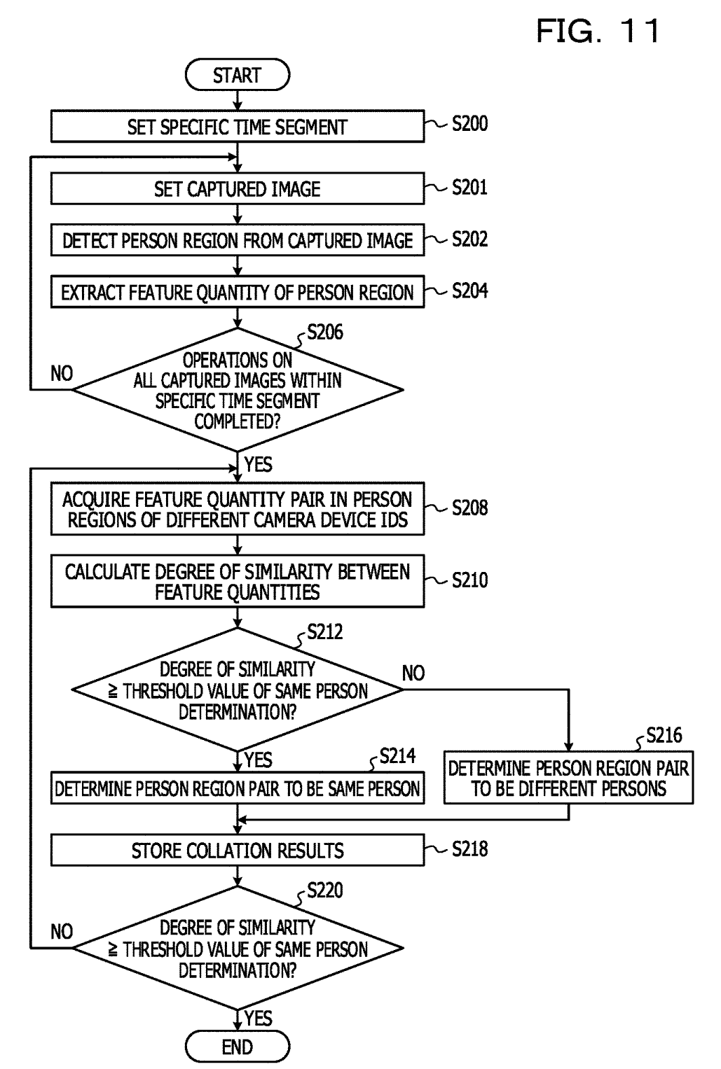

In step S100 of the threshold value setting process of FIG. 10, the event detection apparatus 20 reads each captured image in the image table stored on the image memory unit 24, and collates the images for the same person. Step S100 is performed on a same person determination process of FIG. 11.

In step S200 of the same-person determination process of FIG. 11, the person detection unit 26 sets a specific time segment corresponding to the imaging time of a captured image read from the image memory unit 24. Person collation is performed in the person regions in the images captured during the specific time segment.

In step S201, the person detection unit 26 sets one captured image from among the captured images stored on the image memory unit 24.

In step S202, the person detection unit 26 detects a person region from the captured image set in step S201.

In step S204, the feature extraction unit 28 extracts as a feature quantity a color histogram in the person region detected in step S202, and stores on the person memory unit 30 the feature quantity, the person region ID, the camera device ID, and the imaging time in association with each other.

In step S206, the feature extraction unit 28 determines whether the operations in steps S201 through S204 have been performed on all the captured images within the specific time segment. If the feature extraction unit 28 determines that the operations in steps S201 through S204 have been performed on all the captured images stored on the image memory unit 24 and having the photographing times falling within the specific time segment, processing proceeds to step S208. If there remains on the image memory unit 24 a captured image within the specific time segment which has not undergone the operations in steps S201 through S204, processing returns to step S201.

In step S208, the person collation unit 32 acquires a pair of feature quantities of the person regions having different camera device IDs from the person information table on the person memory unit 30.

In step S210, the person collation unit 32 calculates the degree of similarity between a pair of feature quantities of the person regions acquired in step S208.

In step S212, the person collation unit 32 determines the degree of similarity calculated in step S210 is equal to or above a threshold value of the same person determination. If the degree of similarity is equal to or above the threshold value of the same person determination, processing proceeds to step S214. If the degree of similarity is less than the threshold value of the same person determination, processing proceeds to step S216.

In step S214, the person collation unit 32 determines that a person region pair acquired in step S208 are the same person.

In step S216, the person collation unit 32 determines that the person region pair acquired in step S208 are different persons.

In step S218, the person collation unit 32 stores onto a memory (not illustrated) the collation results obtained in step S214 or S216.

In step S220, the person collation unit 32 determines whether the operations in steps S208 through S218 have been performed on all camera device ID pairs stored in the person information table on the person memory unit 30. If the operations in steps S208 through S218 have been completed on all camera device ID pairs stored in the person information table on the person memory unit 30, the same person determination process ends. If there remains an camera device ID pair in the person information table on the person memory unit 30 which has not undergone the operations in steps S208 through S218, processing returns to step S208.

In step S102 of the threshold value setting process of FIG. 10, the threshold value setting unit 34 calculates the number of moving persons between each pair of the camera device IDs under the normal condition, based on the allocation results of the person regions obtained in step S100.

In step S104, the threshold value setting unit 34 sets to be the criteria value a mean value of the moving persons under the normal condition on each of the camera device ID pairs, and sets, to be the threshold value, N times the standard deviation of the numbers of moving persons under the normal condition. The threshold value setting unit 34 stores the set criteria value and threshold value of anomaly determination and the camera device ID in association with each other on the threshold value memory unit 36.

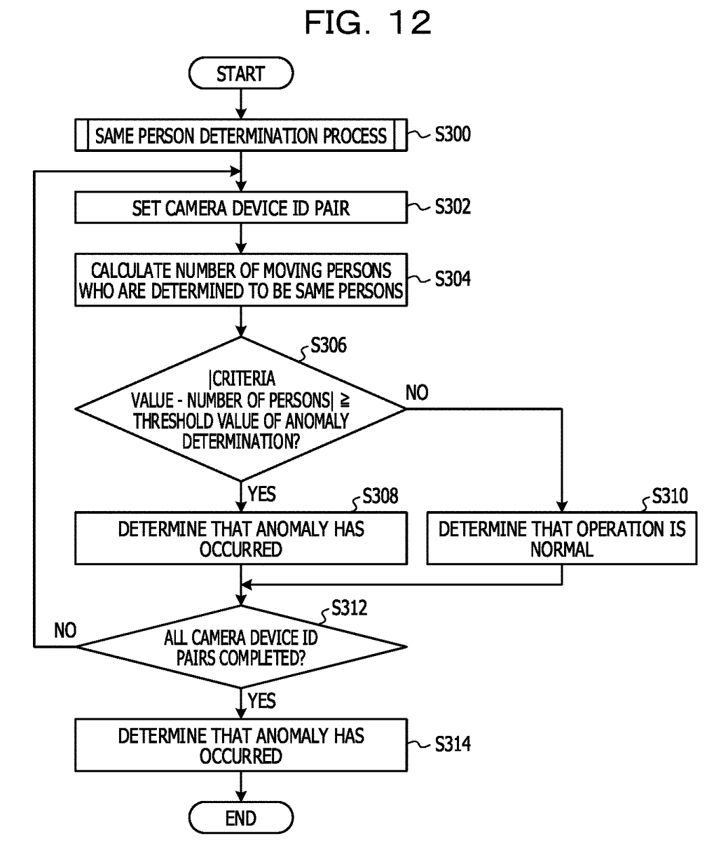

The anomaly determination process is described below. In the event detection system 100 under the normal state, the multiple camera devices 10 successively capture images, and the image acquisition unit 22 in the event detection apparatus 20 acquires each of the images captured by the camera devices 10. When each of the captured images acquired by the image acquisition unit 22 is stored in the image table of the image memory unit 24, the event detection apparatus 20 performs the anomaly determination process of FIG. 12.

In step S300, the same person determination process of FIG. 11 is performed. In step S300, a determination is made as to whether the person regions in each of the pairs of different camera device IDs are the same person or not.

In step S302, the anomaly determination unit 38 sets a pair of different the camera device IDs.

Based on the collation results of the person regions obtained in step S300, in step S304, the anomaly determination unit 38 counts the number of person regions that are determined to be the same person in the pair of different the camera device IDs set in step S302. The anomaly determination unit 38 then calculates the number of moving persons between the different camera device IDs set in step S302.

In step S306, the anomaly determination unit 38 reads from the threshold value memory unit 36 the criteria value and threshold value of anomaly determination corresponding to the pair of the camera device IDs set in step S302. In accordance with the following relationship, the anomaly determination unit 38 determines whether an anomaly has occurred or not.

|Criteria value−Number of moving persons|≧Threshold value of anomaly determination.

If the absolute value of the difference between the read criteria value and the number of moving persons is equal to or above the threshold value of anomaly determination in the above relationship, the anomaly determination unit 38 proceeds to step S308, and then determines that an anomaly has occurred. On the other hand, if the absolute value of the difference between the read criteria value and the number of moving persons is less than the threshold value of anomaly determination in the above relationship, the anomaly determination unit 38 proceeds to step S310, and then determines that the normal condition has been detected.

In step S312, the anomaly determination unit 38 determines whether the operations in steps S302 through S308 have been performed on all camera device ID pairs stored in the image table on the image memory unit 24 within the specific time segment. If the operations in steps S302 through S308 have been performed on all camera device ID pairs stored in the image table on the image memory unit 24 within the specific time segment, processing proceeds to step S314. If there remains an camera device ID pair which is stored in the image table on the image memory unit 24 within the specific time segment and which has not undergone the operations in steps S302 through S308, processing returns to step S302.

In step S314, the anomaly determination unit 38 outputs the determination results obtained in step S308 or S310 on each of the camera device ID pairs. The display 40 displays the determination results that are obtained by the anomaly determination unit 38 and indicate whether an anomaly has occurred or not. The anomaly determination process thus ends.

As described above, the event detection apparatus of the first embodiment acquires the captured images respectively from the multiple image devices. The event detection apparatus detects an anomaly by comparing with the event detection criteria an extraction status from the captured image, from another camera device, having the feature quantity satisfying a specific similarity criteria with the feature quantity extracted from the captured image from a specific camera device. In this way, an anomaly may be detected even if the anomaly has occurred at a location different from the photographing area of the image device.

### Second Embodiment

An event detection system of a second embodiment is described below. The second embodiment is different from the first embodiment in that the threshold value of anomaly determination is controlled in response to variations in the feature quantity extracted from the captured image in the second embodiment. Elements in the event detection system of the second embodiment identical to those of the event detection system 100 of the first embodiment are designated with the same reference numerals and the discussion thereof is omitted herein.

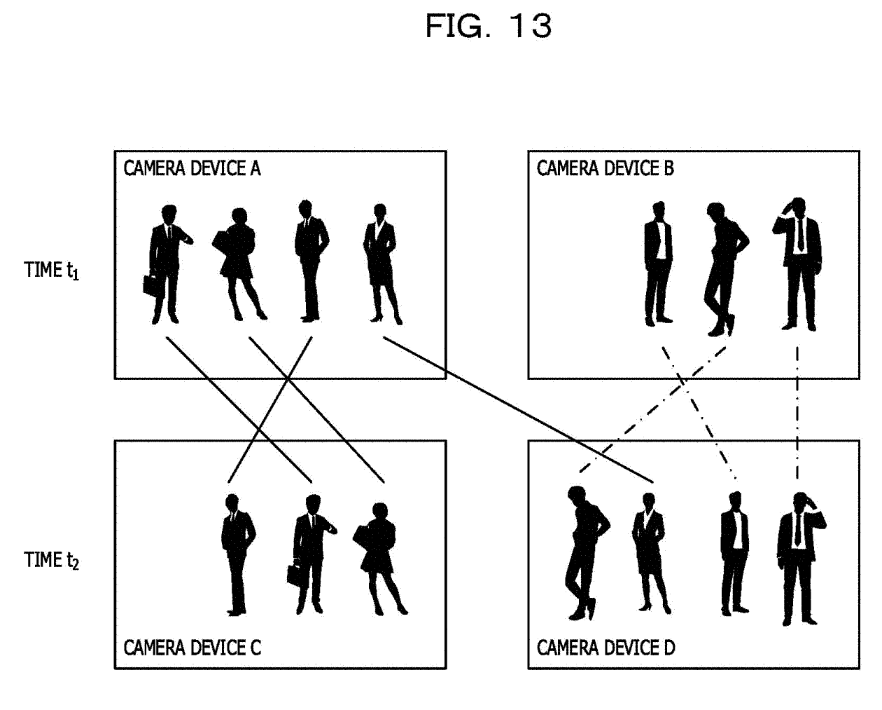

FIG. 13 illustrates an image captured by an camera device A at time t₁, an image captured by an camera device B at time t₁, an image captured by an camera device C at time t₂, and an image captured by the camera device D at time t₂. Note that relationship t₂>t₁ holds.

Referring to FIG. 13, the number of persons commonly photographed in both the captured image from the camera device A and the captured image from the camera device C is three. The number of persons commonly photographed in both the captured image from the camera device A and the captured image from the camera device D is one. The number of persons commonly photographed in both the captured image from the camera device B and the captured image from the camera device D is three. As illustrated in FIG. 13, the persons are varied in clothes, and feature quantities extracted from the person regions in the captured images are also varied. Because of the variations, an error in person collation is less likely to occur. Line segments connecting persons in FIG. 13 represent an example of the person collation results, and thus indicate that the person collation has been correctly performed.

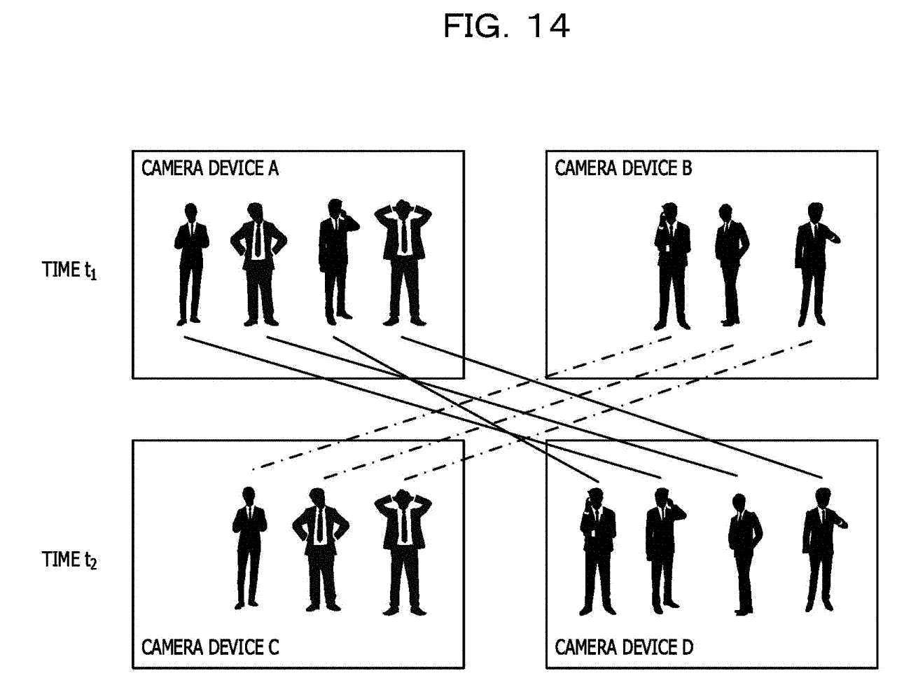

In the example of FIG. 14, in the same way as in FIG. 13, out of the photographed persons, the number of persons commonly photographed in both the captured image from the camera device A and the captured image from the camera device C is three. The number of persons commonly photographed in both the captured image from the camera device A and the captured image from the camera device D is one. The number of persons commonly photographed in both the captured image from the camera device B and the captured image from the camera device D is three.

As illustrated in FIG. 14, the persons are varied less in clothes, and feature quantities extracted from the person regions in the captured images are also varied less. Because of this, an error in person collation is more likely to occur. Line, segments connecting persons in FIG. 14 represent an example of erroneous person collation results. If an error occurs in the person collation in this way, there may be a high possibility that the anomaly determination based on the collation is erroneous.

In accordance with the second embodiment, the threshold value of anomaly determination is controlled in response to variations in the feature quantity extracted from the captured image. More specifically, the threshold value of anomaly determination is controlled such that an anomaly is more difficult to detect as the magnitude of the variations in the feature quantities of the person regions extracted from the captured images from the camera devices 10 is smaller.

More in detail, in accordance with the second embodiment, the threshold value of anomaly determination is controlled to be higher as the magnitude of the variations in the feature quantity of each person region extracted from the captured images from the camera devices 10 is smaller. Also, the threshold value of anomaly determination is controlled to be lower as the magnitude of the variations in the feature quantity of each person region extracted from the captured images from the camera devices 10 is larger. The process is described below more in detail.

The threshold value setting unit 34 of the second embodiment sets a camera device ID pair. The threshold value setting unit 34 calculates the standard deviation of the feature quantities, based on the feature quantities of the person regions detected from the camera device ID pairs under the normal condition. The calculation method of the standard deviation of the feature quantities is described below.

Feature quantities X extracted from N person regions are expressed by formula (1). In formula (1), each x of x⁽¹⁾, x⁽²⁾, . . . , x^{(N)} is a vector representing a color histogram serving as a feature quantity.

X={x⁽¹⁾,x⁽²⁾, . . . ,x^{(N)}} (1)

The threshold value setting unit 34 calculates a mean vector μ using the feature quantities X extracted from the N person regions in accordance with formula (2).

$$μ = \frac{1}{N} {\sum }_{k = 1}^{N} {x}^{( k )} \qquad ( 2 )$$

The threshold value setting unit 34 calculates a variance vector ν using the calculated mean vector μ in accordance with formula (3). The threshold value setting unit 34 calculates a standard deviation vector σ from the variance vector ν. Each element in the standard deviation vector σ is a standard deviation of each bin of the color histogram serving as the feature quantity.

$$σ = \sqrt{v} \\ v = \frac{1}{N - 1} {\sum }_{k = 1}^{N} ‖ {x}^{( k )} - μ ‖ \qquad ( 3 )$$

Symbols ∥ ∥ in formula (3) represent Euclidean norm, and is calculated in accordance with formula (4). M represents the number of bins of the color histogram (the number of dimensions of the feature quantity).

$$‖ x ‖ = \sqrt{{\sum }_{i = 1}^{M} {( {x}_{i} )}^{2}} \qquad ( 4 )$$

The threshold value setting, unit 34 calculates the sum of the elements of the standard deviation vector σ as the standard deviation of the feature quantities. Each element of the standard deviation vector σ is the standard deviation of each bin of the color histogram. By summing the elements, the standard deviation of the whole color histogram is calculated.

If the standard deviation of the feature quantities is equal to or above the threshold value of the feature quantity, the threshold value setting unit 34 calculates the number of moving persons between a pair of camera device IDs per unit time, using the collation results of the person regions from which the feature quantity is extracted. The threshold value of the feature quantity is set in advance.

More in detail, with each pair of the image device IDs under normal condition, the threshold value setting unit 34 repeatedly measures the number of moving persons between the camera device ID pair under the normal condition for a specific period of time, in accordance with the collation results that are provided by the person collation unit 32 and have the standard deviation of the feature quantities higher than the threshold value of the feature quantity. The threshold value setting unit 34 calculates a range of the number of moving persons under the normal condition. More specifically, the threshold value setting unit 34 sets to be the criteria value the mean value of the numbers of persons under the normal condition at the camera device ID pair, and sets to be the threshold value the standard value of the numbers of persons under the normal condition. The threshold value setting unit 34 stores onto the threshold value memory unit 36 the set criteria value and threshold value of anomaly determination and the camera device ID pair in association with each other.

In accordance with the second embodiment, if the standard deviation of the feature quantities is equal to or above the threshold value, the number of moving persons between the locations in the photographing areas of a pair of camera devices per unit time under the normal condition is calculated, and the person regions having larger variations in the feature quantity are used. In this way, the criteria value and threshold value of anomaly determination are calculated from the information having less errors in the collation of the person regions.

In accordance with the embodiment, when a deviation is determined from a past moving tendency analyzed under the normal conditions, the threshold value of anomaly determination, serving as an example of an event detection criteria, is modified in response to the variations in the feature quantities of the person regions detected from the captured images. An anomaly is detected by comparing with the modified threshold value of anomaly determination with the deviation of the current moving tendency from the criteria value indicating the past moving tendency analyzed under the normal condition.

Based on the collation results obtained by the person collation unit 32 in real time, the anomaly determination unit 38 of the second embodiment calculates the number of moving persons between the locations corresponding to the pair of different camera devices 10, and detects an anomaly by comparing the number of moving persons with the threshold value of anomaly determination. The anomaly determination unit 38 also reads the threshold value of anomaly determination on each pair of camera device IDs from the threshold value memory unit 36, and controls the threshold value of anomaly determination such that the threshold value of anomaly determination is larger as the variations in the feature quantities extracted from the person regions of the captured images become smaller. The anomaly determination unit 38 also controls the threshold value of anomaly determination such that the threshold value of anomaly determination is smaller as the variations in the feature quantities extracted from the person regions of the captured images become larger.

More specifically, the anomaly determination unit 38 calculates the standard deviation of the feature quantities extracted from the person regions on each pair of different image device IDs in accordance with the person regions obtained by the person detection unit 26 in real time. Based on the collation results of the person regions obtained by the person collation unit 32 in real time, the anomaly determination unit 38 calculates the number of moving persons between a pair of different camera devices responsive to each pair of different camera device IDs.

The anomaly determination unit 38 reads the threshold value of anomaly determination from the threshold value memory unit 36 on each pair of imagine device IDs, and re-sets the threshold value of anomaly determination in accordance with the following formula (5). The threshold value of anomaly determination stored on the threshold value memory unit 36 is the standard deviation of the number of moving persons under the normal condition.

Threshold value of anomaly determination←(N+1/standard deviation of feature quantities)×(threshold value of anomaly determination) (5)

In accordance with formula (5), the threshold value of anomaly determination becomes higher as the variations in the feature quantities of the person regions are smaller (as the person regions look more similar to each other), and the threshold value of anomaly determination becomes closer to the standard deviation of N×(number of moving persons) as the variations in the feature quantities of the person regions are larger (as the person regions look less similar to each other).

The anomaly determination unit 38 detects on each pair of camera device IDs that an anomaly has occurred if the number of moving persons falls outside the criteria value by the threshold value of anomaly determination or more, by referencing the calculated number of moving persons and the threshold value of anomaly determination that is determined in accordance with the criteria value and the standard deviation of the feature quantities stored on the threshold value memory unit 36.

The process of the event detection system 100 of the second embodiment is described below.

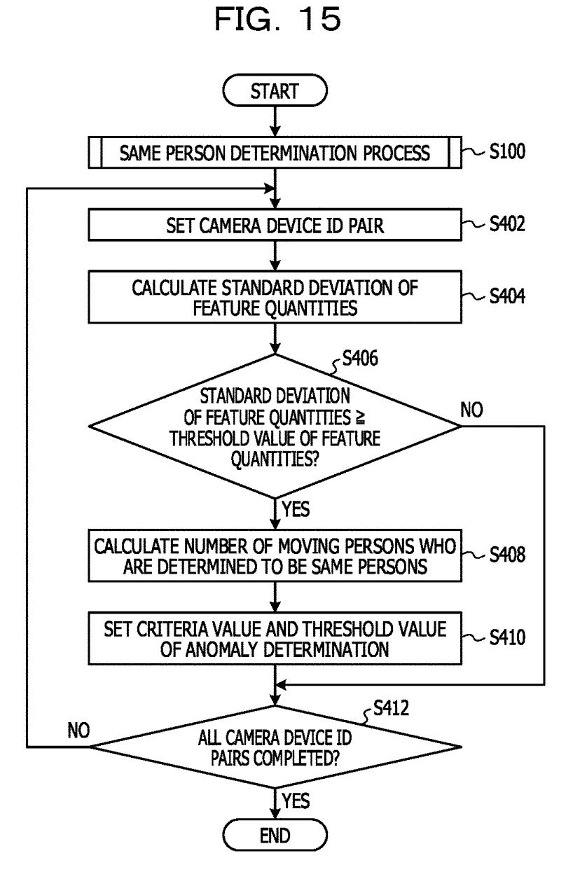

The threshold value setting process to set the criteria value and the threshold value of anomaly determination is described below. In the event detection system 100 under the normal condition, the camera devices 10 capture images, and the image acquisition unit 22 in the event detection apparatus 20 acquires of the images captured by the camera devices 10. When each of the captured images acquired by the image acquisition unit 22 is stored in the image table of the image memory unit 24, the event detection apparatus 20 performs the threshold value setting process of FIG. 15. Each of operations in the threshold value setting process is described below.

In step S100 of the threshold value setting process of FIG. 15, the event detection apparatus 20 reads each captured image in the image table stored on the image memory unit 24, and performs the same person determination process of the same person in the captured images. Step S100 is performed in the same person determination process of FIG. 11.

In step S402, the threshold value setting unit 34 sets a pair of camera device IDs.

In step S404, the threshold value setting unit 34 calculates the standard deviation of the feature quantities corresponding to the pair of image device IDs set in step S402 in accordance with the detection results of the person regions in step S100.

In step S406, the threshold value setting unit 34 determines whether the standard deviation of the feature quantities is equal to or above the threshold value of the feature quantities. If the standard deviation of the feature quantities is equal to or above the threshold value of the feature quantities, processing proceeds to step S408. If the standard deviation of the feature quantities is less than the threshold value of the feature quantities, processing proceeds to step S412.

In step S408, for a specific period of time, the threshold value setting unit 34 measures the number of moving persons between a pair of camera device IDs under the normal condition with respect to the pair of image device IDs set in step S402 in accordance with the collation results of the person regions obtained in step S100. The threshold value setting unit 34 thus calculates the number of moving persons under the normal condition.

In step S410, the threshold value setting unit 34 sets to be the criteria value the mean value of the numbers of moving persons calculated in step S408 with respect to the pair of camera device IDs set in step S402, and sets to be the threshold value the standard deviation of the numbers of moving persons calculated in step S408. The threshold value setting unit 34 stores on the threshold value memory unit 36 the set criteria value and threshold value of anomaly determination and the pair of camera device IDs in association with each other.

In step S412, a determination is made as to whether the operations in steps S402 through S410 have been performed on all the pairs of camera device IDs stored in the image table on the image memory unit 24 within the specific time segment. If the operations in steps S402 through S410 have been performed on all the pairs of camera device IDs stored in the image table on the image memory unit 24 within the specific time segment, the threshold value setting process ends. If there remains in the image table on the image memory unit 24 a pair of camera device IDs that has not undergone the operations in steps S402 through S410 within the specific time segment, processing returns to step S402.

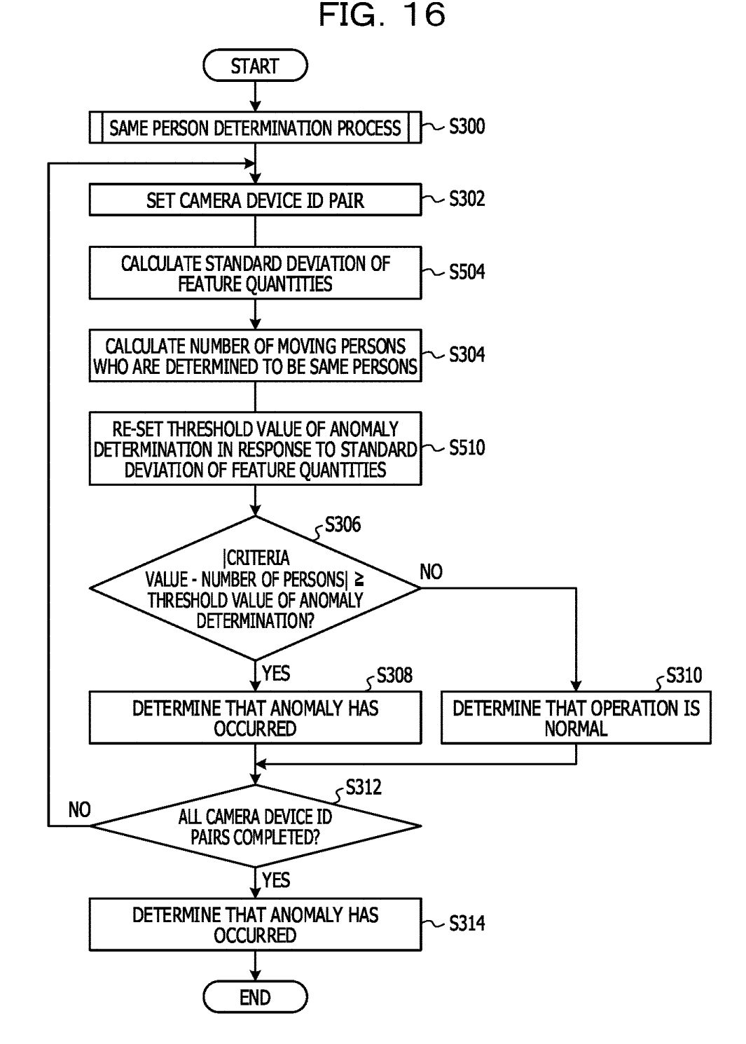

The anomaly determination process is described below. In the event detection system 100 under the normal condition, the camera devices 10 successively capture images, and the image acquisition unit 22 in the event detection apparatus 20 acquires of the images captured by the camera devices 10. When each of the captured images acquired by the image acquisition unit 22 is stored in the image table of the image memory unit 24, the event detection apparatus 20 performs the anomaly determination process of FIG. 16.

In step S300, the same person determination process of FIG. 11 is performed. In step S300, the person regions of the same person are determined with respect to each of different camera device IDs.

In step S302, the anomaly determination unit 38 sets a pair of different camera device IDs.

In step S503, the anomaly determination unit 38 calculates the standard deviation of the feature quantities extracted from the person regions of the camera device ID pair set in step S302, in accordance with the collation results of the person regions obtained in step S300 in real time.

In step S304, the anomaly determination unit 38 counts the number of person regions that are determined to be the same person in the pair of different the camera device IDs set in step S302, in accordance with the collation results of the person regions obtained in step S300. The anomaly determination unit 38 then calculates the number of moving persons between the different camera device IDs set in step S302.

In step S510, the anomaly determination unit 38 reads the threshold value of anomaly determination from the threshold value memory unit 36, and re-sets the threshold value of anomaly determination such that the threshold value of anomaly determination is higher as the standard deviation of the feature quantities calculated in step S503 is smaller. The anomaly determination unit 38 also re-sets the threshold value of anomaly determination such that the threshold value of anomaly determination is lower as the standard deviation of the feature quantities calculated in step S503 is larger.

The operations in steps S306 through S314 of FIG. 16 are performed in the same way as in the first embodiment, and the anomaly determination process is thus complete.

As described above, the event detection apparatus of the second embodiment acquires the captured images respectively from the multiple image devices. The event detection apparatus detects an anomaly by comparing with the threshold value of anomaly determination with an extraction status from the captured image, from another camera device, having the feature quantity satisfying a specific similarity criteria with the feature quantity extracted from the captured image from a specific camera device. In this way, the threshold value of anomaly determination is controlled such that an anomaly is more difficult to detect as the variations in each of the feature quantities extracted from the captured images become smaller. Even if a collation error is likely to occur in the feature quantities extracted from the captured images, erroneous anomaly detection is controlled so that an anomaly is appropriately detected.

As described above, the event detection program 60 is installed on the storage unit 53. The disclosure is not limited to this configuration. The program related to the embodiments may be supplied in a recorded form on one of recording media, including a compact-disk read-only memory (CD-ROM), a digital versatile disk ROM (DVD-ROM), and a universal serial bus (USB) memory.

Modifications of the embodiments are described below.

In accordance with the embodiments, the person regions representing persons are detected from the captured images, and an anomaly is detected in response to the number of moving persons representing the number of person regions. The disclosure is not limited to this configuration. A region representing another target object may be detected from the captured images. For example, a vehicle region representing a vehicle may be detected from the captured images, and an anomaly may be detected in response to the number of moving vehicles. In accordance with the embodiments, the standard deviation of the feature quantities extracted from the person regions is used as an example of variations in each feature quantity. The disclosure is not limited to this configuration. For example, the variance of feature quantities may be used.

In accordance with the embodiments, an anomaly is detected in response to the number of moving persons. The disclosure is not limited to this configuration. For example, an anomaly may be detected using the travel times of movements of people, and a movement ratio of moving persons.

If an anomaly is detected using the travel times of the moving persons, the anomaly determination unit 38 calculates the travel time of the person regions between a pair of different image devices with respect to each pair of different camera device IDs, in accordance with the collation results of the person regions obtained by the person collation unit 32 in real time. Since imaging time is associated with a person region ID as illustrated in FIG. 5, the anomaly determination unit 38 calculates a difference between the imaging times of a pair of person regions that are determined to be the same person as a travel time of the movement of the person. The anomaly determination unit 38 calculates the mean travel times of the movements of the person regions on each pair of different camera device IDs. If the mean travel time of the movements is different from the criteria value by the threshold value of anomaly determination or more on each pair of different camera device IDs, the anomaly determination unit 38 detects an anomaly that has occurred.

For a specific period of time, the threshold value setting unit 34 measures the travel time of the movement of the person regions between a pair of camera device IDs under the normal condition with respect to each pair of camera device IDs, in accordance with the collation results of the person regions. In a way similar to the way described in the embodiments, the criteria value and threshold value of anomaly determination are set.

If an anomaly is detected using the movement ratio of moving persons, the anomaly determination unit 38 calculates the number of moving persons between a pair of different camera devices with respect to each pair of different camera device IDs, in accordance with the collation results of the person regions obtained by the person collation unit 32 in real time. On each camera device ID, the anomaly determination unit 38 calculates the total sum of moving persons during the specific time segment, thereby calculating a movement ratio representing a percentage of person regions having moved from a different camera device ID.

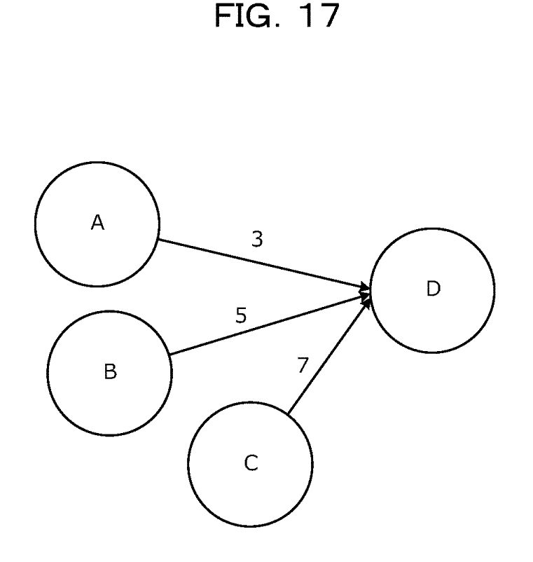

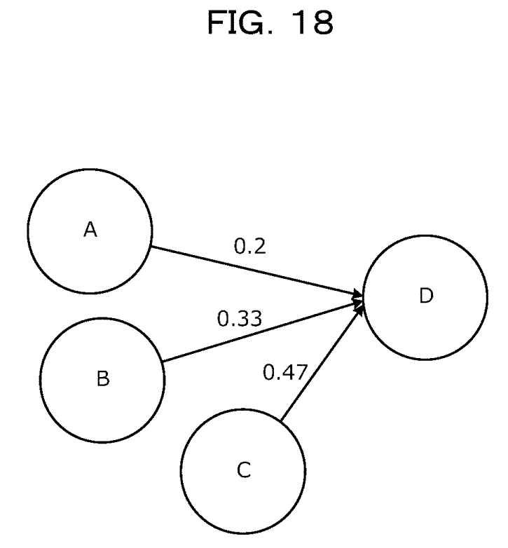

As illustrated in FIG. 17, for example, camera devices A through D are mounted. The number of persons who have moved from the location of the camera device A to the location of the camera device D may now be three, the number of persons who have moved from the location of the camera device B to the location of the camera device D may now be five. Also, the number of persons who have moved from the location of the camera device C to the location of the camera device D may now be seven. In such a case, the total sum of moving persons from the locations of the camera devices A, B, and C to the location of the camera device D are 15. To calculate the movement ratio as illustrated in FIG. 18, the number of persons from each of the locations of camera devices to the location of the camera device D is divided by the total sum of the moving persons to calculate the movement ratio of each camera device.

The anomaly determination unit 38 detects the occurrence of an anomaly on each camera device ID if the movement ratio from a different camera device different from a camera device of interest is different from the criteria value by the threshold value of anomaly determination or more.

Based on the collation results of the person regions, the threshold value setting unit 34 measures the movement ratio of persons between a pair of camera device IDs under the normal condition on each pair of camera device IDs for a specific period of time. In a similar way to the way of the embodiments, the criteria value and threshold value of anomaly determination are thus set.

In accordance with the embodiments, an anomaly is detected as an example of an event, for example. The disclosure is not limited to this configuration. For example, whether an event is held or not may be detected in response to a moving tendency of a target object. If dwelling is detected in the movement tendency of target objects, an event having customer attracting effect may be currently being held.

In accordance with the embodiments, the threshold value of anomaly determination is controlled such that an anomaly is more difficult to detect as the variations in the feature quantities of the person regions extracted from within the captured images are smaller in accordance with formula (5). The disclosure is not limited to this configuration. For example, the occurrence of an anomaly is detected only if the standard deviation of the feature quantities of the detected person regions is equal to or above a predetermined threshold value.

In accordance with the embodiments, based on the collation results obtained by the person collation unit 32, the threshold value setting unit 34 sets to be the criteria value the mean value of moving persons between a pair of different camera devices and sets to be the threshold value of anomaly determination the value that is N times the standard deviation. The present disclosure is not limited to this configuration. For example, the number of moving persons under the normal condition is manually calculated, and the criteria value and threshold value of anomaly determination may then be set.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing an event detection program that causes a computer to perform a process, the process comprising:
acquiring a first captured image captured at a first timing by a first camera device;
acquiring a second captured image captured at a second timing after the first timing by a second camera device;
detecting an event in accordance with a first image feature extracted from the first captured image, a second image feature extracted from the second captured image and an event detection criteria, the event detection criteria making the event less detectable as a variance of the first image feature or a variance of the second image feature is smaller, both the first image feature and the second image feature corresponding to one or more target objects included in each of the first captured image and the second captured image; and
outputting a result of the detecting of the event.

2. The non-transitory computer-readable storage medium according to claim 1, wherein
the event detection criteria is defined such that a value indicated by the event detection criteria is higher as the variance of the first image feature or the variance of the second image feature is smaller while the value indicated by the event detection criteria is lower as the variance of the first image feature or the variance of the second image feature is larger; and wherein
the process comprises:
detecting, in the detecting, the event a value indicated based on the first image feature and the second image feature is equal to or above the value indicated by the event detection criteria.

3. The non-transitory computer-readable storage medium according to claim 1, wherein
both the first image feature and the second image feature is an image feature in one or more person regions included in each of the first captured image and the second captured image; and
the event detection criteria makes the event less detectable as a variance of image feature between the one or more person regions is smaller; and wherein
the process comprises:
specifying, based on the first image feature and the second image feature, at least one of factors including a number of moving persons, a movement ratio of the persons and a travel time; and
detecting the event based on the at least one of factors and the event detection criteria.

4. An event detection apparatus comprising:
a memory; and
a processor coupled to the memory and the processor configured to:
acquire a first captured image captured at a first timing by a first camera device;
acquire a second captured image captured at a second timing after the first timing by a second camera device;
detect an event in accordance with a first image feature extracted from the first captured image, a second image feature extracted from the second captured image and an event detection criteria, the event detection criteria making the event less detectable as a variance of the first image feature or a variance of the second image feature is smaller, both the first image feature and the second image feature corresponding to one or more target objects included in each of the first captured image and the second captured image; and
output a result of the detecting of the event.

5. An event detection method executed by a computer, the event detection method comprising:
acquiring a first captured image captured at a first timing by a first camera device;
acquiring a second captured image captured at a second timing after the first timing by a second camera device;
determining whether an event occurs based on a difference between a first image feature and a second image feature, both the first image feature and the second image feature corresponding to one or more target objects included in each of the first captured image and the second captured image; and
outputting information indicating occurrence of the event when it is determined that the event occurs.
